(19) United States
(12) Patent Application Publication
(10) Pub. No.: US 2020/0129009 A1
(43) Pub. Date: Apr. 30, 2020

(54) ROASTING STICK WITH PIVOTING SKEWER

(71) Applicant: Robert S. Hurt, Becker, MN (US)

(72) Inventor: Robert S. Hurt, Becker, MN (US)

(21) Appl. No.: 16/666,892

(22) Filed: Oct. 29, 2019

Related U.S. Application Data
(60) Provisional application No. 62/751,847, filed on Oct. 29, 2018.

(51) Int. Cl. A47J 37/07; A47J 37/04

(52) U.S. Cl. CPC A47J 37/0786; A47J 2037/0795; A47J 37/041

(57) ABSTRACT

This disclosure relates to a roasting implement that allows a user to flip a retained food item through a quick jerking movement. The preferred assembly of the roasting implement includes a telescopic rod portion extending from a handle culminating in a pivoting skewer assembly for generally enabling movement of skewer assembly when the implement is moved in a sudden and quick upward motion.

### CROSS-REFERENCE TO RELATED APPLICATION

This U.S. Patent Application Patent Application claims priority to U.S. Provisional Patent Application: 62/751,847 filed Oct. 29, 2018, the disclosure of which is considered part of the disclosure of this application and is hereby incorporated by reference in its entirety.

### FEDERALLY SPONSORED RESEARCH OR DEVELOPMENT

Not Applicable

### SEQUENCE LISTING, A TABLE, OR A COMPUTER PROGRAM

Not Applicable

### FIELD OF THE INVENTION

This invention relates generally to a roasting stick with a pivoting skewer assembly for generally receiving a food item to be roasted over a heat source. In one aspect, the roasting stick includes a telescopic handle portion that is movable from a collapsed position to an extended position for easy transport and storage.

### BACKGROUND

Roasting food items over a heat source, such as a campfire, has been a pastime enjoyed by generations of individuals. Typically to roast these food items, such as marshmallows, hot dogs, sausages, or other food items, a user will utilize a cooking implement in the form of a long stick, an extended fork, or a specialty roasting implement to extend the food item over the heat source while the user is in a safe position adjacent to the heat source. To evenly cook the food, the user will often rotate this implement. This nearly constant rotation can be tedious, difficult, and result in strain on the wrist and hands of the user.

Within the prior art, U.S. Pat. No. 8,826,808 to the above-named inventor has been utilized as one mechanism that generally allows a user to flip a food item for even heating through a jerking motion. Although this '808 reference remains useful, a new and improved assembly has been developed that utilizes less material and is provided in a more compact assembly for easier use and travel.

### BRIEF SUMMARY OF THE INVENTION

In one aspect, this disclosure is related to a roasting implement that allows a user to flip a retained food item through a quick jerking movement.

In another aspect, this disclosure is related to a roasting implement having a telescopic handle portion with an end opposed the handle configured with a pivoting skewer assembly for generally enabling movement of skewer assembly when the implement is moved in a sudden and quick upward motion.

The roasting implement device of the present disclosure comprises a rod extending a length between a first end and a second end. The first end being a handle portion generally configured for grasping by a user and comprising an insulated material that will not transfer heat from the second end and rod length to a user of the device. Accordingly, the handle portion is preferably constructed out of a plastic material or wood.

The second end generally functioning as the working end of the device and configured for the receipt of a pivoting skewer assembly. The pivoting skewer assembly comprising a plurality of skewers hingedly received and movable between a first position and a second position in an arch of approximately 180 degrees, wherein this movement flips food items received on the skewers between a first side and a second side. The plurality of skewers comprising a first skewer extending perpendicular to the length of the rod and coupled to at least a second skewer also extending perpendicular to the length of the rod and spaced a distance from the first skewer. In the preferred coupling, the first skewer and the at least a second skewer are connected through at least one support extending parallel to the rod length.

In the preferred assembly, the pivoting skewer assembly has a length extending coplanar with the rod from the second end opposite the first end. The pivoting skewer assembly formed from a pair of halves, with each half of the pair of halves being identical in shape and size having an aperture and recess to form a tunnel, wherein each half of the pair of halves is configured in an assembly to sandwich the first skewer of the plurality of skewers to allow for rotation. The length of the skewer assembly being longer than the plurality of skewers to provide a resting surface for the plurality of skewers in the first position.

In the preferred embodiment of the present disclosure, the rod portion of the device is provided in a telescopic assembly, wherein the rod includes a plurality of collapsible/expandable sections enabling the length of the device to be altered between a retracted position and an extended position. Accordingly, this telescopic assembly is comprised of generally tubular hollow sections having a tapered diameter configured for the nested receipt of each other. In the preferred assembly, the telescopic assembly will have the largest tubular and hollow section adjacent to the first end and received within the handle, wherein the device is retracted into the handle of the first end.

The invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF THE DRAWINGS

FIG. 1 is a perspective view of device in both an extended and retracted position, according to the present disclosure;

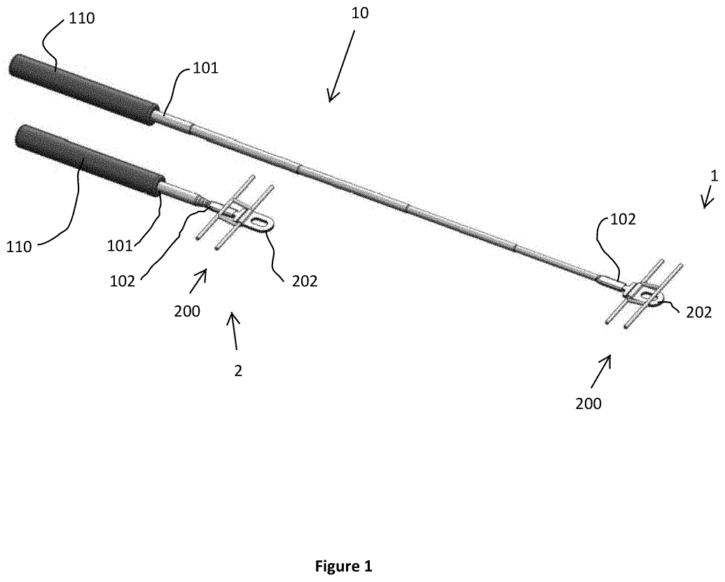

FIG. 2 is a view of the second end of the device with the plurality of skewers in a first position, according to the present disclosure;

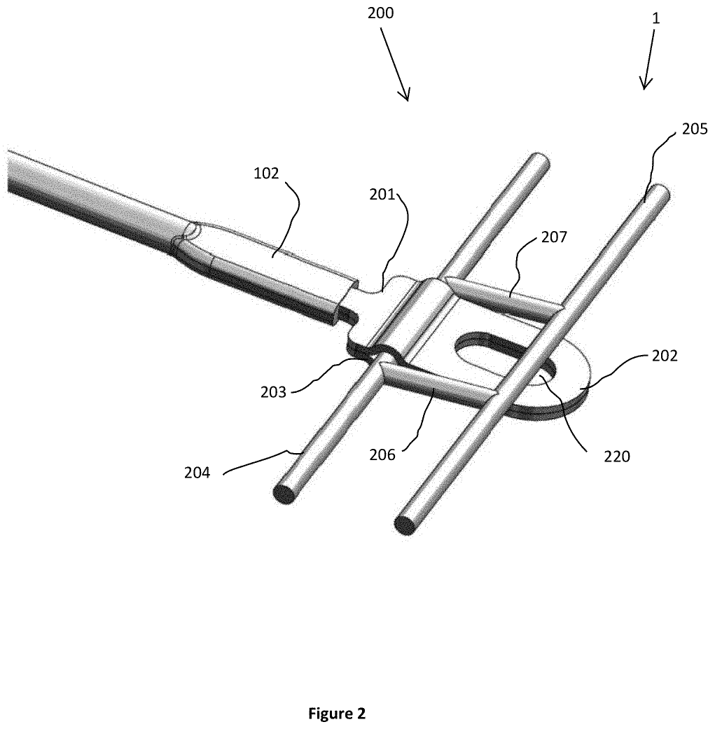

FIG. 3 is a view of the second end of the device with the plurality of skewers in a second position, according to the present disclosure; and

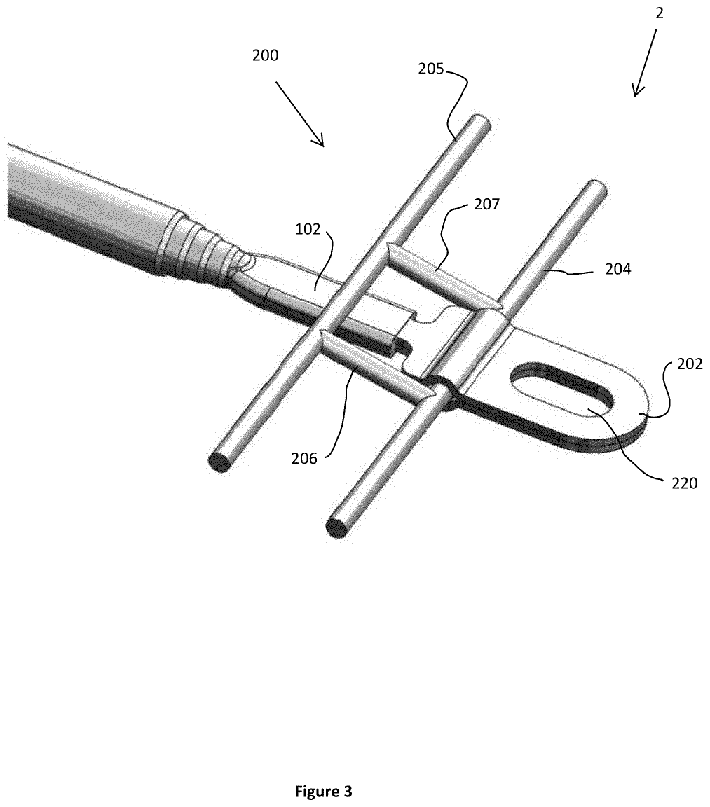

FIG. 4 is an exploded view of device in a retracted position, according to the present disclosure.

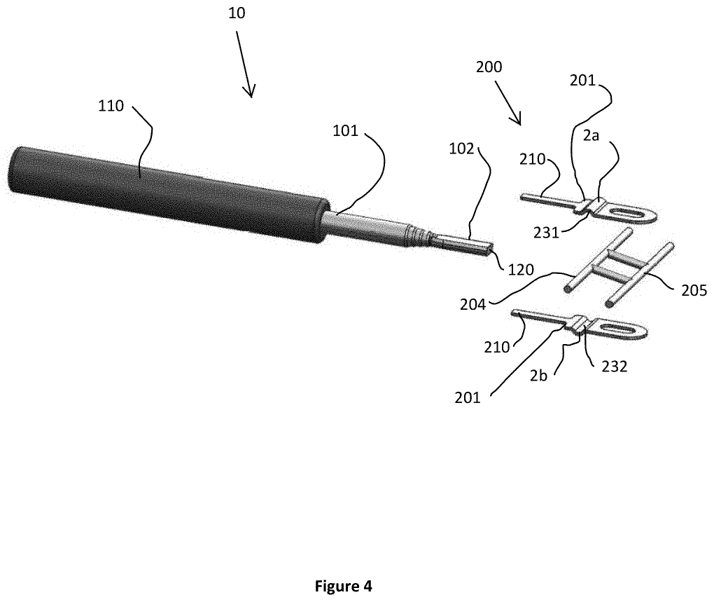

### DETAILED DESCRIPTION OF THE INVENTION

The following detailed description includes references to the accompanying drawings, which forms a part of the detailed description. The drawings show, by way of illustration, specific embodiments in which the invention may be practiced. These embodiments, which are also referred to herein as “examples,” are described in enough detail to enable those skilled in the art to practice the invention. The embodiments may be combined, other embodiments may be utilized, or structural, and logical changes may be made without departing from the scope of the present invention. The following detailed description is, therefore, not to be taken in a limiting sense.

Before the present invention of this disclosure is described in such detail, however, it is to be understood that this invention is not limited to particular variations set forth and may, of course, vary. Various changes may be made to the invention described and equivalents may be substituted without departing from the true spirit and scope of the invention. In addition, many modifications may be made to adapt a particular situation, material, composition of matter, process, process act(s) or step(s), to the objective(s), spirit or scope of the present invention. All such modifications are intended to be within the scope of the disclosure made herein.

Unless otherwise indicated, the words and phrases presented in this document have their ordinary meanings to one of skill in the art. Such ordinary meanings can be obtained by reference to their use in the art and by reference to general and scientific dictionaries.

References in the specification to “one embodiment” indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The following explanations of certain terms are meant to be illustrative rather than exhaustive. These terms have their ordinary meanings given by usage in the art and in addition include the following explanations.

As used herein, the term “and/or” refers to any one of the items, any combination of the items, or all of the items with which this term is associated.

As used herein, the singular forms “a,” “an,” and “the” include plural reference unless the context clearly dictates otherwise.

As used herein, the terms “include,” “for example,” “such as,” and the like are used illustratively and are not intended to limit the present invention.

As used herein, the terms “preferred” and “preferably” refer to embodiments of the invention that may afford certain benefits, under certain circumstances. However, other embodiments may also be preferred, under the same or other circumstances.

Furthermore, the recitation of one or more preferred embodiments does not imply that other embodiments are not useful and is not intended to exclude other embodiments from the scope of the invention.

As used herein, the terms “front,” “back,” “rear,” “upper,” “lower,” “right,” and “left” in this description are merely used to identify the various elements as they are oriented in the FIGS., with “front,” “back,” and “rear” being relative to the apparatus. These terms are not meant to limit the elements that they describe, as the various elements may be oriented differently in various applications.

As used herein, the term “coupled” means the joining of two members directly or indirectly to one another. Such joining may be stationary in nature or movable in nature. Such joining may be achieved with the two members or the two members and any additional intermediate members being integrally formed as a single unitary body with one another or with the two members or the two members and any additional intermediate members being attached to one another. Such joining may be permanent in nature or alternatively may be removable or releasable in nature. Similarly, coupled can refer to a two member or elements being in communicatively coupled, wherein the two elements may be electronically, through various means, such as a metallic wire, wireless network, optical fiber, or other medium and methods.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the disclosure.

The present disclosure is related to a roasting implement, generally referred to as device 10 that allows a user to flip a retained food item through a quick jerking movement. The device 10 comprises a rod 100 having a length extending between a first end 101 and a second end 102. The first end 101 having a handle 110 configured for grasping by a user and comprising an insulated material that will not transfer heat from the second end and rod length to a user of the device. Accordingly, the handle 110 is preferably constructed out of a plastic material or wood. In an embodiment of the device 10 of the present disclosure the handle 110 having include an aperture configured for the receipt of the rod 100 first end 101 in an assembly, wherein the first end 101 of the rod 100 is received within an interior of the handle 110.

The second end 102 functioning as the working end of the device 10 and configured for the receipt of a pivoting skewer assembly 200. The pivoting skewer assembly 200 having a first end 201 opposite a second end 202 with a distance between the first end 201 and the second end 202 defining a length of the pivoting skewer assembly 200. The pivoting skewer assembly 200 forming a generally planar surface having a first aperture 203 adjacent to the first end 201 extending across a width of the assembly 200 between opposed edges. A second aperture 220 is positioned adjacent to the second end 202 extending through a thickness of the assembly 200 from a top side to a bottom side, wherein this second aperture 220 is most generally used as a loop to allow for receipt of a hook for hanging the device 10 when it is not in use.

The first aperture 203 sized for the hinged receipt of a first skewer 204 of a plurality of skewers 204, 205. The plurality of skewers 204, 205 configured for movement within the aperture 203 and movable between a first position 1 and a second position 2 in an arch of approximately 180 degrees, wherein this movement flips the food items received on the plurality of skewers 204, 205 between a first side and a second side. The plurality of skewers 204, 205 culminate in ends that are generally blunt in nature but of a diameter to allow for the attachment of food articles by puncturing the food articles for retaining the food article on the plurality of skewers 204, 205.

The plurality of skewers 204, 205 comprising the first skewer 204 extending perpendicular to the length of the rod 100 and coupled to at least a second skewer 205 also extending perpendicular to the length of the rod 100 and spaced a distance from the first skewer 204. In the preferred coupling, the first skewer 204 and the at least a second skewer 205 are connected through at least one support 206 extending parallel to the rod 100 length and defining the spaced distance between the first skewer 204 and the at least a second skewer 205. Preferably, the assembly includes a second support 207 extending parallel to the at least one support 206 a distance between the supports 206, 207 corresponding to the width of the assembly 200 to prevent lateral movement of the plurality of skewers 204, 205 during use. The spaced distance between the first skewer 204 and the at least a second skewer 205 being less than the distance of the length of the pivoting skewer assembly 200, wherein the at least a second skewer 205 is rested upon the top side of the planar surface of the pivoting skewer assembly 200 in the first position 1.

In the preferred assembly, the pivoting skewer assembly 200 is formed from a pair of halves 2a, 2b, with each half 2a, 2b, of the pair of halves 2a, 2b, being identical in shape and size having a recess 231, 232 to form a tunnel representing the aperture 203. Accordingly, this assembly is configured to sandwich the first skewer 204 of the plurality of skewers 204, 205 to allow for rotation between the positions of skewer assembly 200. Within this preferred assembly, the second end 102 of the rod 100 includes a cavity 120 having a size and shape configured for the receipt of a tab 210 of the first end 201 of pivoting skewer assembly 200.

In the preferred embodiment of the present disclosure, the rod 100 portion of the device 10 is provided in a telescopic assembly, wherein the rod 100 includes a plurality of collapsible/expandable sections enabling the length of the device 10 to be altered between a retracted position 3 and an extended position 4. Accordingly, this telescopic assembly is comprised of generally tubular hollow sections having a tapered diameter configured for the nested receipt of each other and configured for movement and adjustment of the length of the telescopic assembly. In the preferred assembly, the telescopic assembly will have the largest tubular and hollow section adjacent to the first end 101 and received within the handle 110, wherein the device 10 is retracted into the handle 110 of the first end 101.

The device 10 and its assembly is configured to enable motion of the skewers 204, 205 upon a sudden movement of the device 10, wherein this motion will allow the skewers 204, 205 rotate about the axis of the receipt of the first skewer 204 within the aperture 203. Accordingly, a quick, jerk-like, movement of the wrist, during use of the device 10 will allow the at least second skewer 205 to rotate about this axis.

Further, allow it is preferred for ease of use, the skewer assembly 200 could contain more than two skewers or more than two rods to allow for additional support of additional skewers, wherein the device 10 may include a multitude of individual skewers within the skewer assembly 200, provided a single skewer is hingedly received on the assembly 200.

While the invention has been described above in terms of specific embodiments, it is to be understood that the invention is not limited to these disclosed embodiments. Upon reading the teachings of this disclosure many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

What is claimed is:

1. A roasting device for a food item, the device comprising:
a rod having a first end and a second end opposed the first end with a distance between the first end and the second end defining a length of the rod; and
a pivoting skewer assembly, the pivoting skewer assembly movable between a first position and a second position the pivoting skewer assembly comprising:
a first skewer, the first skewer extending perpendicular to the length of the rod and hingedly coupled to the second end;
at least a second skewer, the at least a second skewer extending perpendicular to the length of the rod; and
at least one support coupled to the first skewer and the at least a second skewer a distance between the first skewer and the at least a second skewer.

2. A roasting device as in claim 1, wherein the rod portion is comprised of a telescopic assembly, wherein the length of the rod is adjustable between the first end and the second end.

3. A roasting device as in claim 1, wherein the rod first end includes a handle.

4. A roasting device as in claim 1, wherein the pivoting skewer assembly includes a second support coupled to the first skewer and the second skewer.

5. A roasting device for a food item allowing a user to flip the food item between a first side and a second side through an upward jerking motion, the device comprising:
a rod having a first end opposed a first distance from a second end; and
a pivoting skewer assembly, the pivoting skewer assembly comprising:
a planar surface having a first end, a second end opposite the first end and defining a length between the first end and the second end, and a width;
a first aperture adjacent to the first end and extending the width of the planar surface; and
a plurality of skewers coupled for hinged movement to the first aperture and configured for movement along the length of the planar surface between a first position and a second position.

6. A roasting device as in claim 5, wherein the rod portion is comprised of a telescopic assembly, wherein the length of the rod is adjustable between the first end and the second end a second distance.

7. A roasting device as in claim 5, wherein the rod first end includes a handle.

8. A roasting device as in claim 5, wherein the plurality of skewers comprises:
a first skewer, the first skewer extending perpendicular to the length of the rod and received within the first aperture;
at least a second skewer, the at least a second skewer extending perpendicular to the length of the rod; and
at least one support coupled to the first skewer and the at least a second skewer a distance between the first skewer and the at least a second skewer, the distance between the first skewer and the at least a second skewer being less than the length of the planar surface.

9. A roasting device as in claim 8, wherein the pivoting skewer assembly includes a second support coupled to the first skewer and the second skewer.

10. A roasting device as in claim 5, wherein the planar surface includes a second aperture, the second aperture adjacent to the second end and extending through a thickness of the planar surface.

11. A roasting device as in claim 5, wherein the pivoting skewer assembly planar surface is comprised of a pair of halves.

12. A roasting device for a food item allowing a user to flip the food item between a first side and a second side through an upward jerking motion, the device comprising:
a rod having a first end opposed a first distance from a second end; and
a pivoting skewer assembly, the pivoting skewer assembly comprising:
a planar surface having a first end, a second end opposite the first end and defining a length between the first end and the second end, and a width;
a first aperture adjacent to the first end and extending the width of the planar surface;
a second aperture adjacent to the second end extending through a thickness of the planar surface; and
a plurality of skewers coupled for hinged movement to the first aperture and configured for movement along the length of the planar surface between a first position and a second position in an arch of 180 degrees.

13. A roasting device as in claim 12, wherein the rod portion is comprised of a telescopic assembly, wherein the length of the rod is adjustable between the first end and the second end a second distance.

14. A roasting device as in claim 12, wherein the rod first end includes a handle.

15. A roasting device as in claim 12, wherein the plurality of skewers comprises:
a first skewer, the first skewer extending perpendicular to the length of the rod and received within the first aperture;
at least a second skewer, the at least a second skewer extending perpendicular to the length of the rod; and
at least one support coupled to the first skewer and the at least a second skewer a distance between the first skewer and the at least a second skewer, the distance between the first skewer and the at least a second skewer being less than the length of the planar surface.

16. A roasting device as in claim 15, wherein the pivoting skewer assembly includes a second support coupled to the first skewer and the second skewer.

17. A roasting device as in claim 12, wherein the pivoting skewer assembly planar surface is comprised of a pair of halves.
